(19) United States
(12) Patent Application Publication
(10) Pub. No.: US 2005/0016172 A1
(43) Pub. Date: Jan. 27, 2005

(54) Brake booster device

(76) Inventor: Kaoru Tsubouchi, Toyota-shi (JP)

Correspondence Address: BURNS DOANE SWECKER & MATHIS L L P, POST OFFICE BOX 1404, ALEXANDRIA, VA, 22313-1404, US

(21) Appl. No.: 10/909,847

(22) Filed: Aug. 3, 2004

(30) Foreign Application Priority Data
Apr. 22, 2003 (JP) 2003-117422

(51) Int. Cl. B60T 8/24

(52) U.S. Cl. 60/552

(57) ABSTRACT

Disclosed is a brake booster device wherein the construction of a valve mechanism and in particular, of a negative pressure valve seat are simplified, so that the circumferential length of the negative pressure valve seat and the area through which the pressure difference between a constant pressure chamber and a variable pressure chamber acts on a negative pressure valve can be easily set or designed to meet the valve characteristic. The brake booster device is of the type that when the stepping force exerted on a brake pedal causes a plunger and an output piston to move relative to each other, switching is carried out to make a variable pressure chamber communicate with either of the atmosphere and a constant pressure chamber and that the pressure difference between the variable pressure chamber and the constant pressure chamber is thus caused to move a partition member and an output piston forward, whereby an output rod is pushed to generate pressurized brake fluid in a master cylinder. In the brake booster device of the aforementioned type, closed, elongate negative pressure valve seats are protruded from a rear end flat surface portion of the output piston to encircle passages communicating with the constant pressure chamber, while an annular valve seat is formed at the rear surface of the plunger to encircle an atmosphere leading passage. Negative pressure valves and an atmosphere valve respectively contactable with the negative pressure valve seats and the atmosphere valve seat are formed on a valve member at respective positions spaced in the axial direction. Communication passages are provided at the outer surface of the valve member between the negative pressure valves and the atmosphere valve to make the interior of the valve member with the variable pressure chamber.

### INCORPORATION BY REFERENCE

This application is based on and claims priority under 35 U.S.C. sctn. 119 with respect to Japanese Application No. 2003-117422 filed on Apr. 22, 2003, the entire content of which is incorporated herein by reference.

### BACKGROUND OF THE INVENTION

1. Field of the Invention

The present invention relates to a brake booster device incorporated in a brake system for motor vehicles.

2. Discussion of the Related Art

Heretofore, there has been known a brake booster device as described in Japanese unexamined, published patent application No. 9-39777 (1997-39777). In the known brake boost device, the interior of a booster shell is divided by a diaphragm into a variable pressure chamber and a constant pressure chamber, and an output piston is secured to the diaphragm. The movement of the diaphragm in the forward and backward direction is transmitted from the output piston to an output rod through a reaction mechanism, whereby a plunger connected to the reaction mechanism is axially moved by a brake pedal. A cylindrical portion receiving the plunger therein is protruded backward from the output piston, and the cylindrical portion air-tightly passes through a rear wall of the booster shell to extend backward. At the bottom surface of the output piston, a negative pressure valve seat is formed to extend annually around the internal surface of the cylindrical portion, and an annular groove between the negative pressure valve seat and the internal surface of the cylindrical portion is in communication with the variable pressure chamber by way of a passage formed in the output piston. Further, an annular atmosphere valve seat is formed on the rear surface of the plunger. A valve member is air-tightly fit in the cylindrical portion of the output piston and is provided with a negative pressure valve and an atmosphere valve which are respectively contactable with the negative pressure valve seat and the atmosphere valve seat. The valve member is received in the cylindrical portion and is urged forward by a compression spring. A communication passage is formed on the side wall portion of the valve member between the negative pressure valve and the atmosphere pressure valve, and the communication passage makes the interior of the internal surface of the valve member communicate with the variable pressure chamber.

However, in the aforementioned prior art device, the negative pressure valve seat is annually formed around the internal surface of the cylindrical portion at the bottom or rear end surface of the output piston, and the negative pressure valve which is air-tightly fit in the cylindrical portion is brought selectively into contact and out of contact thereby to selectively open or close the annular groove formed between the negative pressure valve seat and the internal surface of the cylindrical portion, so that the variable pressure chamber and the constant pressure chamber can be brought selectively into communication with each other or isolation therefrom. This disadvantageously makes the negative pressure valve complicated in construction and also make it difficult that the circumferential length of the negative pressure valve seat and the area through which the pressure difference between the low (i.e., constant) pressure chamber and the variable pressure chamber acts on the negative pressure valve can be altered or changed as desired to meet the valve characteristic.

### SUMMARY OF THE INVENTION

Accordingly, it is a primary object of the present invention to provide a brake booster device having an improved valve mechanism in which the circumferential length of a negative pressure valve seat and the area through which the pressure difference between a constant pressure chamber and a variable pressure chamber acts on a negative pressure valve can be set or designed as desired taking account of the valve characteristic.

Another object of the present invention is to provide a brake booster device having an improved valve mechanism in which the circumferential length of a negative pressure valve seat and the area through which the pressure difference between a constant pressure chamber and a variable pressure chamber acts on a negative pressure valve can be designed independently of either or both of the diameters of an atmosphere valve seat and an atmosphere valve.

Briefly, according to the present invention, there is provided a brake booster device comprising a booster shell having a partition member partitioning the interior of the booster shell into a variable pressure chamber and a constant pressure chamber; an output piston secured to the partition member and having a negative pressure valve seat formed thereon; an output rod; a reaction mechanism for transmitting the movement in the forward and backward direction of the partition member caused by the pressure difference between the variable and constant pressure chambers from the output piston to the output rod; a plunger operable in connection with the reaction mechanism and having an atmosphere valve seat formed thereon; an input rod connected to the plunger for axially moving the plunger when axially moved by a brake pedal; and a valve member having a negative pressure valve and an atmosphere valve formed thereon. The negative pressure valve is contactable with the negative pressure valve seat for selective communication of the variable pressure chamber with the constant pressure chamber. The atmosphere valve is contactable with the atmosphere valve seat for selective communication of the variable pressure chamber with the atmosphere. The brake booster device further comprises a first spring urging the valve member to bring the negative pressure valve and the atmosphere valve respectively into contact with the negative pressure valve seat and the atmosphere valve seat; a second spring urging the plunger to move backward away from the output rod; and a restraining member for restraining the backward movement of the plunger caused by the second spring, relative to the output piston. The negative pressure valve seat is protruded from a rear end flat surface of the output piston to encircle a passage communicating with the constant pressure chamber. The atmosphere valve seat is annularly formed at the rear surface of the plunger to encircle an atmosphere leading passage. The negative pressure valve and the atmosphere valve respectively contactable with the negative pressure valve seat and the atmosphere valve seat are formed on the valve member at positions spaced in the axial direction of the valve member. A communication passage is formed at the side portion of the valve member between the negative pressure valve and the atmosphere valve to make the interior of the valve member communicate with the variable pressure chamber.

With this construction, since the negative pressure valve seat is protruded from the rear end flat surface portion of the output piston to encircle the passage communicating with the constant pressure chamber and since the negative pressure valve contactable with said negative pressure valve seat is formed on the valve member, the negative pressure valve can be simplified in configuration, and the circumferential length of the negative pressure valve seat and the area through which the pressure difference between the constant and variable pressure chambers acts on the negative pressure valve can be easily designed to meet a desired valve characteristic.

### BRIEF DESCRIPTION OF THE ACCOMPANYING DRAWINGS

The foregoing and other objects and many of the attendant advantages of the present invention may readily be appreciated as the same becomes better understood by reference to the preferred embodiments of the present invention when considered in connection with the accompanying drawings, wherein like reference numerals designate the same or corresponding parts throughout several views, and in which:

FIG. 1 is a longitudinal sectional view of a brake booster device in the first embodiment according to the present invention;

FIG. 2 is an enlarged fragmentary sectional view of a valve mechanism incorporated in the brake booster device shown in FIG. 1;

FIG. 3 is a cross-sectional view taken along the line III-III in FIG. 2;

FIG. 4 is a cross-sectional view taken along the line IV-IV in FIG. 2; and

FIG. 5 is an enlarged fragmentary sectional view of another valve mechanism in the second embodiment according to the present invention.

### ETAILED DESCRIPTION OF THE PREFERRED EMBODIMENTS

(First Embodiment)

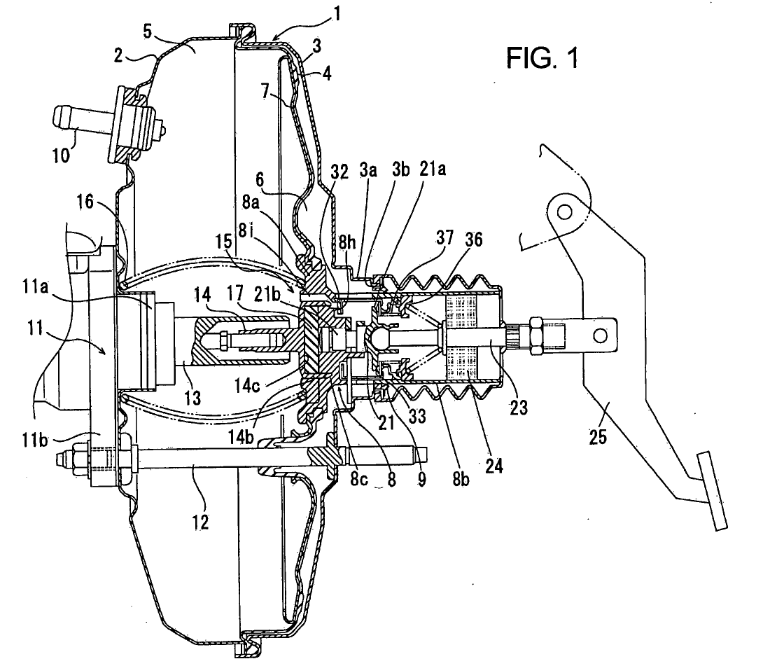

A brake booster device in the first embodiment according to the present invention will be described hereinafter with reference to the accompanying drawings. Referring now to FIG. 1, a booster shell 1 is composed of a front shell 2 and a rear shell 3. Between the both shells 2 and 3, a flexible diaphragm 4 serving as a partition member is secured air-tightly at its outer circumferential bead portion and partitions the interior of the booster shell 1 into a constant pressure chamber 5 and a variable pressure chamber 6. A disc-like plate 7 is laminated to the diaphragm 4 within the constant pressure chamber 5. An output piston 8 is air-tightly secured at the outer surface of a base portion 8a thereof to the diaphragm 4 and the plate 7 and exposes the forward end surface within the constant pressure chamber 5. The rear shell 3 is bent at its center portion outwardly thereby to protrude a cylindrical protruding portion 3a backward and has a through hole 3b formed to extend on the axis of the rear shell 3. The output piston 8 protrudes a slidable, cylindrical portion 8b backward from the base portion 8a, and the slidable, cylindrical portion 8b passes through the through hole 3b to protrude backward from the protruding portion 3a of the booster shell 1. A sealing element 9 is interposed between the internal surface of the through hole 3b and the outer surface of the slidable, cylindrical portion 8b to isolate the variable pressure chamber 6 from the atmosphere. A negative-pressure leading conduit 10 is attached to the front shell 2, and the constant pressure chamber 5 is in communication with an intake manifold of a combustion engine (both not shown) thereby to be kept at a predetermined negative pressure.

A numeral 11 denotes a master cylinder, which air-tightly passes at its one or rear end 11a through a center hole formed at the center portion of the front shell 2, with a flange portion 11b thereof being in abutting engagement with the forward end surface of the front shell 2. The front shell 2 and the rear shell 3 are joined with each other with several (e.g., two) tie rods 12, each of which extends in parallel with the axis of the booster shell 1 composed of the both shells 2, 3 at almost radial mid position between the axis and the outer surface of the booster shell 1 and secured to the master cylinder 11. A sliding hole of each sealing portion formed on the diaphragm 4 is fit on each tie rod 12 to be air-tightly slidable therealong as it keeps the air-tight partitioning between the constant pressure chamber 5 and the variable pressure chamber 6.

A numeral 13 denotes a master piston, which is inserted into the master cylinder 11 slidably in the forward and backward direction. The master piston 13 protrudes from the rear end portion of the master cylinder 11 to extend close to the forward end of the output piston 8. An output rod 14 is interposed between the output piston 8 and the master piston 13. The output piston 8 transmits the forward movement of the diaphragm 4 depending on the pressure difference between the constant pressure chamber 5 and the variable pressure chamber 6, to the output rod 14 through a reaction mechanism 15 thereby to cause the output rod 14 to pressure the master piston 13 forward. A return spring 16 is interposed between the front shell 2 and the output piston 8 to urge the same backward.

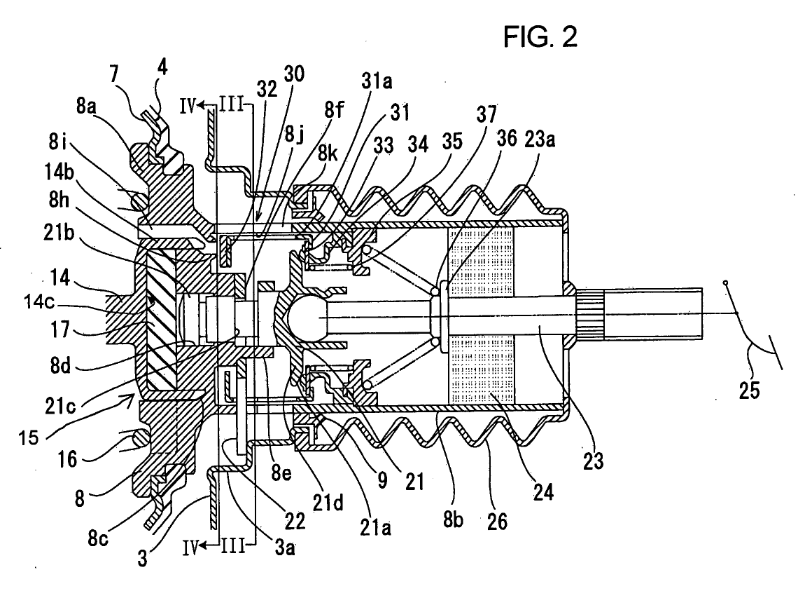

As best shown in FIG. 2, the reaction mechanism 15 takes the configuration that an annular protrusion 14b formed at the rear end of the output rod 14 is inserted into an annular recess 8c, which is formed in the output piston 8 to extend from the forward end surface thereof backward, axially slidably relative to the output piston 8. Thus, a reaction chamber 14c is formed at the forward end portion of the output piston 8 to be encircled by the annular protrusion 14b, and a disc-like reaction member 17 made of an elastic material is received in the reaction chamber 14c. When compressed between a reaction end surface partitioned by the annular recess 8c of the output piston 8 and a bottom surface of the reaction chamber 14c, the reaction member 17 generates a pressure which depends on the force that the output piston 8 pressures the output rod 14 and hence, the master piston 13.

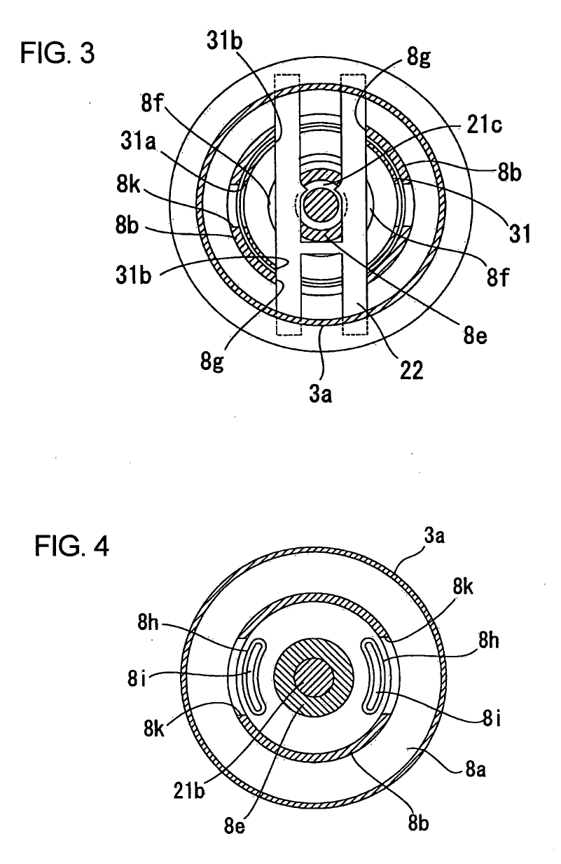

Referring now to FIGS. 2 through 4, a numeral 21 designates a plunger having an atmosphere valve seat 21a formed thereon. A forwardly protruding rod portion 21b of the plunger 21 is slidably inserted into a reaction hole 8d, which is formed at the base portion 8a of the output piston 8 to pass through the base portion 8a in the axial direction, and makes the forward end surface thereof face the rear end surface of the reaction member 17. The base portion 8a of the output piston 8 protrudes a cylindrical portion 8e axially backward. At the radially opposite outer portions (i.e., both side portions) of the cylindrical portion 8e, as clearly understood by the comparison of FIG. 3 with FIG. 4, two slots 8f, 8f each reaching the reaction hole 8d are formed extending in a direction perpendicular to a radial line connecting two negative pressure valve seats 8h, 8h which will be referred to later in detail.

A numeral 22 denotes a key member taking the shape of “H” letter and serving as a restraining member. Straight portions which are formed at the opposite sides of the key member 22 are fit respectively in the slots 8f, 8f to get partly in an annular groove 21c formed on the rod portion 21b of the plunger 21. The both end portions of the key member 22 are respectively inserted into, and slidably guided along, two engaging slots 8g, 8g of an elongate arc shape which are formed on the slidable cylindrical portion 8b at diametrically opposite positions. The key member 22 is prevented from coming off from the cylindrical portion 8e since latch portions formed at inner sides of the both side straight portions are engaged with the bottom surface of the annular recess 21c with a cross-beam portion thereof being kept in contact with the outer surface of the cylindrical portion 8e. Thus, the output piston 8 and the plunger 21 are able to axially move relative to each other by a limited distance which is determined by subtracting double the thickness of the key member 22 from the sum of the widths of the slot 8f and the annular groove 21c. The rear end of the plunger 21 is connected to an input rod 23 as the same is swingable relative to the plunger 21. The input rod 23 passes through an air filter element 24 to extend backward beyond the slidable, cylindrical portion 8b and is connected to a brake pedal 25 in a usual manner.

As shown in FIGS. 2 and 4, a valve mechanism 30 is further provided for making the variable pressure chamber 6 communicate selectively with the constant pressure chamber 5 and the atmosphere. The valve mechanism 30 includes two negative pressure valve seats 8h, 8h, which are protruded from the rear end flat surface portion of the base portion 8a at radially opposite positions inside of the slidable, cylindrical portion 8b of the output piston 8 to be surrounded or encircled thereby. More specifically, each negative pressure valve seat 8h takes the shape of a closed ridge or ledge and is formed at the rear end flat surface portion of the base portion 8a to protrude along the circumferential edge of each elongate hole or passage 8i which is curved or crooked along an arc having the center on the axis of the output piston 8. The passages 8i, 8i respectively encircled by the negative pressure valve seats 8h, 8h are formed to pass through the base portion 8a and serve to make the variable pressure chamber 6 and the constant pressure chamber 5 communicate with each other. An expansion portion 21d is formed at the axial mid portion of the plunger 21, and the annular atmosphere valve seat 21a is formed at the rear surface of the expansion portion 21 d to surround an air leading passage which is formed around the internal surface of the slidable, cylindrical portion 8b.

A cylindrical valve member 31 is axially slidably received with a play in a valve hole 8j which is defined by the internal surface of the slidable, cylindrical portion 8b. Two flat negative pressure valves 32 are secured to the forward end surface of an annular end portion which is bent radially inwardly from the forward end of the valve member 31. Each negative pressure valve 32 takes a similar flat shape, which is made much bigger than a corresponding one of the negative pressure valve seats 8h, and is selectively brought into contact or out of contact with the corresponding negative pressure valve seat 8h, so that the variable pressure chamber 6 is selectively isolated from the constant pressure chamber 5 or is made communicate with the same. A rear end annular portion is formed at the rear end of the valve member 31 to be bent radially inwardly. An annular atmosphere valve 33 is secured to the forward end surface of the rear end annular portion and is spaced from the negative pressure valves 32 in the axial direction. The atmosphere valve 33 is selectively brought into contact and out of contact with the atmosphere valve seat 21a, so that the variable pressure chamber 6 is selectively isolated from the atmosphere or is made communicate with the same.

The rear end of the valve member 31 is connected to an annular seal holder 35 by means of a bellows 34 enabling the valve member 31 to move in the axial direction. The seal holder 35 fit in the internal surface of the slidable, cylindrical portion 8b and is urged by a compression spring 36 to be pressured on a stepped shoulder surface formed on the internal surface of the valve hole 8j. The compression spring 36 is interposed between a spring shoe 23a protruding from the axial mid portion of the input rod 23 and the seal holder 35 to urge the input rod and hence, the plunger 21 backward. Another compression spring 37 is interposed between the forward end surface of the seal holder 35 and the rear end surface of the valve member 31 to urge the valve member 31 forward. Communication passages 31a are formed on the valve member 31 to be diametrically opposed between the negative pressure valves 32 and the atmosphere valve 33. Further, two diametrically opposite passage holes 8k are formed on the slidable, cylindrical portion 8b to open to the variable pressure chamber 6 ahead of the sealing element 9 which blocks the variable pressure chamber 6 from the atmosphere. The inside of the valve member 31 is in communication with the variable pressure chamber 6 by way of the communication passages 31a and the passage holes 8k. The valve member 31 is formed at diametrically opposite portions thereof two rectangular holes 31b, along which the key member 22 is moved to be slidable at the outer side surfaces of the both side straight portions. Therefore, the valve member 31 is positioned by the key member 22 against rotation relative to the output piston 8, so that positional relation is kept to make each negative pressure valve seat 8h and each negative pressure valve 32 always face each other.

(Operation)

The operation of the brake booster device as constructed above in the first embodiment will be described hereinafter. When the brake pedal 25 is stepped on thereby to cause the input rod 23 to advance the plunger 21 against the resilient force of the compression spring 36, the valve member 31 is advanced by the resilient force of the compression spring 37. This brings the negative pressure valves 32 into contact with the negative pressure valve seats 8h thereby to block the communication between the variable pressure chamber 6 and the constant pressure chamber 5. As the plunger 21 is advanced further, the atmosphere valve seat 21a is separated from the atmosphere valve 33, whereby the air filtered by the filter element 24 is flown into the variable pressure chamber 6. Thus, the diaphragm 4, the plate 7 and the output piston 8 are moved forward due to the pressure difference between the variable pressure chamber 6 and the constant pressure chamber 5, and the output rod 14 is advanced by the output piston 8 through the reaction member 17 of the reaction mechanism 15. Accordingly, the master piston 13 is pushed forward by the output rod 14, so that pressurized brake oil is generated in the master cylinder 11 in dependence on the stepping force exerted on the brake pedal 25.

The output piston 8 elastically deforms the reaction member 17 by the operating force which corresponds to the pressure difference between the both chambers 5, 6 acting on the diaphragm 4 and pushes the master piston 13 through the reaction member 17 and the output rod 14. When elastically deformed, the reaction member 17 is partly flown into the reaction hole 8d thereby to push the forward end portion of the rod portion 21b of the plunger 21. Thus, the plunger 21 is retracted relative to the output piston 8 to make the atmosphere valve seat 21a take seat on the atmosphere valve 33, whereby the communication of the variable pressure chamber 6 with the atmosphere is blocked to keep a desired pressure of the brake oil. During this operation, the force exerted on the brake pedal 25 is transmitted from the input rod 23 through the rod portion 21b of the plunger 21 to the reaction member 17. Since the reaction member 17 is elastically deformed in dependence on the stepping force, the driver can feel a reaction force corresponding to the deformation of the reaction member 17.

When the brake pedal 5 is released, on the contrary, the plunger 21 is moved by the resilient force of the compression spring 36 backward relative to the output piston 8. Thus, the plunger 21 brings the atmosphere valve seat 21a into contact with the atmosphere valve 33 and moves the valve member 31 backward relative to the output piston 8 against the resilient force of the compression spring 37, whereby the negative pressure valves 32 are separated from the negative pressure valve seats 8h. As a result, the negative pressure in the constant pressure chamber 5 is led to the variable pressure chamber 6 by way of the communication passages 8i to make zero the pressure difference between the variable pressure chamber 6 and the constant pressure chamber 5. Therefore, the output piston 8, the plate 7 and the diaphragm 4 are moved backward by the resilient force of the return spring 16 provided in the booster shell 1, and with the backward movement of the diaphragm 4, the master piston 13 is moved backward by the resilient force of a compression spring (not shown) for origin returning with the result that no pressure of the brake oil is generated in the master cylinder 11.

In this particular embodiment, it becomes easier to set or design the circumferential length of each negative pressure valve seat 8h and the area through which the differential pressure between the constant pressure chamber 5 and the variable pressure chamber 6 acts on each negative pressure valve 32, as desired to meet the valve characteristic. Therefore, the air discharge from the variable pressure chamber 6 to the constant pressure chamber 5 can be performed through the valving operation which is highly responsive and silent.

The plunger 21 is stopped at the same time as the key member 22 is brought into contact with a stepped internal surface of the protruding portion 3a of the rear shell 3, while the output piston 8 is stopped in contact with the key member 22. Thus, while the brake is not applied, the negative pressure valves 32 remain very close to the negative pressure valve seats 8h, so that when the brake begins to be applied, the negative pressure valves 32 can come into contact quickly with the negative pressure valve seats 8h. Further, since the key member 22 is relatively slidable along the engaging holes 8g and the rectangular holes 31b, the valve member 31 can be positioned against rotation relative to the output piston 8, so that the negative pressure valve seats 8h and the negative pressure valves 32 can be kept in the positional relation that they face each other.

(Second Embodiment)

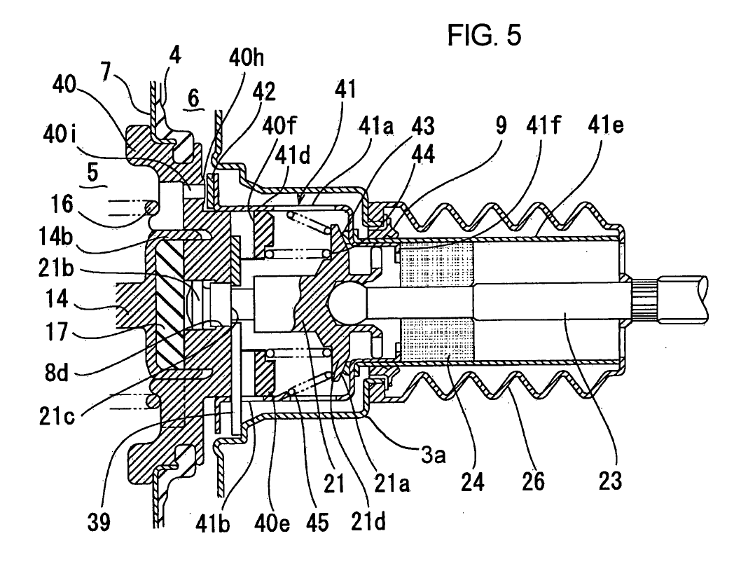

Next, the second embodiment according to the present invention will be described hereafter. The second embodiment whose valve mechanism is shown in FIG. 5 is different from the first embodiment in that the slidable, cylindrical portion is provided not on the output piston but on the valve member. Since other parts in the second embodiment are same as those in the first embodiment, the detailed description for such other parts is omitted in exchanger of assigning the same reference numerals to the same parts. In the second embodiment shown in FIG. 5, the output piston 40 is air-tightly secured at the outer surface thereof to the diaphragm 4 and the plate 7 and exposes the forward and rear end surfaces thereof respectively to the constant pressure chamber 5 and the variable pressure chamber 6. Two negative pressure valve seats 40h (one only shown) are protruded diametrically symmetrically from the rear end flat surface portion of the output piston 40. Each negative pressure valve seat 40h takes the shape of a closed ridge or ledge and is formed at the rear end flat surface portion of the base portion 8a to protrude along the circumferential edge of each elongate hole or passage 40i which is curved or crooked along an arc having the center on the axis of the output portion 40. The passages 40i each encircled by each negative pressure valve seat 40h are formed to pass through the output piston 40 and serve to make the variable pressure chamber 6 and the constant pressure chamber 5 communicate with each other. The output piston 40 is provided at its rear end surface with a cylindrical portion 40e which is protruded as a guide portion radially inside of the negative pressure valve seats 40h. At the radially opposite outer portions of the cylindrical portion 40e, two slots 40f, 40f each reaching the reaction hole 8d are formed extending in a direction perpendicular to a radial line connecting the two negative pressure valve seats 40h, 40h. Straight portions which are formed at the opposite sides of a key member 22 taking the shape of “H” letter are fit respectively in the slots 40f, 40f to be positioned in the rotational direction and get in an annular groove 21c formed on the rod portion 21b of the plunger 21.

The valve member 41 is composed of a valve main body portion 41d and a slidable, cylindrical portion 41e press-fit on the rear end portion of the valve main body portion 41d. At the forward end internal surface of the cylindrical valve main body portion 41d, the valve member 41 is slidably fit on the cylindrical portion 40e of the output piston 40. The valve main body portion 41d is provided with an annular forward end surface bent radially outwardly, and two flat negative pressure valves 42 are secured to the annular forward end surface. Each of the negative pressure valves 42 takes a similar flat shape, which is made much bigger than a corresponding one of the negative pressure valve seats 40h, and is brought selectively into contact or out of contact with a corresponding one of the negative pressure valve seats 40h thereby to make the variable pressure chamber 6 blocked from the constant pressure chamber 5 or communicate with the same. A small-diameter connection portion 41f is formed at the rear end of the valve main body portion 41d. An annular atmosphere valve 43 is protruded at the forward end surface of a stepped portion bent radially inwardly and is spaced from the negative pressure valves 42 in the axial direction. The atmosphere valve 43 is brought selectively into contact and out of contact with the atmosphere valve seat 21a of the plunger 21, so that the variable pressure chamber 6 is selectively made isolated from the atmosphere or communicate with the same.

The rear end portion of the plunger 21 is slidably inserted into the internal surface of the connection portion 41f behind the atmosphere valve 43. By means of a compression spring 44 interposed between the rear end surface of the cylindrical portion 40e of the output piston 40 and the forward end surface of the radially expanded portion 21d of the plunger 21, the plunger 21 is urged backward relative to the output piston 40. The valve member 41 is urged forward by means of another compression spring 45 which is interposed between spring shoes and the forward end surface of the radially expanded portion 21d of the plunger 21. The spring shoes are formed by bending radially inwardly plural parts of the valve main body portion 41d which are spaced circumferentially at predetermined intervals. Communication passages 41a are formed on the valve main body portion 41d to be diametrically opposed between the negative pressure valves 42 and the atmosphere valve 43. The interior of the valve main body portion 41d is in communication with the variable pressure chamber 6 through the communication passages 41a. The valve main body portion 41d is provided at diametrically opposite portions thereof with two rectangular holes 41b, along which the key member 39 is moved to be slidable at the outer side surfaces of the both side straight portions. The valve member 41 is positioned by the key member 39 against rotation relative to the output piston 40, so that positional relation is kept to make the negative pressure valves 42 always face the negative pressure valve seats 40h. The slidable, cylindrical portion 41e which is press-fit on the outer surface of the connecting portion 41f passes through the through hole 3b and protrudes backward from the protruding portion 3a of the booster shell 1. A sealing element 9 is interposed between the internal surface of the through hole 3b and the outer surface of the slidable, cylindrical portion 41e to isolate the variable pressure chamber 6 from the atmosphere. A bellows 26 is secured at forward and rear ends thereof respectively to the protruding portion 3a and the rear end of the slidable, cylindrical portion 41e to cover the outer surface of the same.

In operation, when the brake pedal 25 is stepped on thereby to advance the plunger 21 against the resilient force of the compression spring 44, the valve member 41 is advanced by the resilient force of the compression spring 45 as it is guided along the cylindrical portion 40e and the sealing element 9. This brings the negative pressure valves 42 into contact with the negative pressure valve seats 40h thereby to block the communication between the variable pressure chamber 6 and the constant pressure chamber 5. As the plunger 21 is advanced further, the atmosphere valve seat 21a is separated from the atmosphere valve 43, whereby the air filtered by the filter element 24 is flown into the variable pressure chamber 6. Thus, the diaphragm 4, the plate 7 and the output piston 40 are moved forward, so that pressurized brake oil is generated in the master cylinder 11 in dependence on the stepping force exerted on the brake pedal 25.

When the brake pedal 5 is released, on the contrary, the plunger 21 is moved by the resilient force of the compression spring 44 backward relative to the output piston 40. Thus, the plunger 21 brings the atmosphere valve seat 21a into contact with the atmosphere valve 43 thereby to move the valve member 41 backward relative to the output piston 40, whereby the negative pressure valves 42 are separated from the negative pressure valve seats 40h. As a result, the negative pressure in the constant pressure chamber 5 is led to the variable pressure chamber 6 by way of the communication passages 40i to make zero the pressure difference between the variable pressure chamber 6 and the constant pressure chamber 5. Therefore, the output piston 40, the plate 7 and the diaphragm 10 are moved backward by the resilient force of the return spring 16 provided in the booster shell 1.

Finally, various features and many of the attendant advantages in the foregoing embodiments will be summarized as follows:

In the first embodiment typically shown in FIGS. 1 and 2, when the brake pedal 25 is stepped on thereby to cause the input rod 23 to advance the plunger 21 relative to the output piston 8, the negative pressure valves 32 are brought into contact with the negative pressure valve seats 8h thereby to block the communication between the variable pressure chamber 6 and the constant pressure chamber 5. Then, the atmosphere valve seat 21a is separated from the atmosphere valve 33 to lead the air to the variable pressure chamber 6. The pressure difference between the variable pressure chamber 6 and the constant pressure chamber 5 is taken place to move the diaphragm 4 and the output piston 8 forward to push the output rod 14, whereby a master piston 13 of a master cylinder 11 is advanced to generate pressurized brake oil in the master cylinder 11. When the brake pedal 25 is released, on the contrary, the plunger 21 is moved by the resilient force of the compression spring 36 backward relative to the output piston 8 and the valve member 31. Thus, the atmosphere valve seat 21a is brought into contact with the atmosphere valve 33 thereby to isolate the variable pressure chamber 6 from the atmosphere, while the negative pressure valves 32 are separated from the negative pressure valve seats 8h. As a result, the negative pressure in the constant pressure chamber 5 is led to the variable pressure chamber 6 to make zero the pressure difference between the both chambers 6 and 5, and the diaphragm 4 and the output piston 8 are moved backward by the resilient force of the return spring 16.

As constructed above, since the negative pressure valve seats 8h are protruded from the rear end flat surface portion of the output piston 8 to encircle the passages 8i communicating with the constant pressure chamber 5 and since the negative pressure valves 32 contactable with the negative pressure valve seats 8h are formed on the valve member 31, the negative pressure valves 32 can be simplified in configuration, and the circumferential length of each negative valve seat 8h and the area through which the pressure difference between the constant and variable pressure chambers 5, 6 acts on each negative pressure valve 32 can be easily designed to meet a desired valve characteristic.

Also in the first embodiment typically shown in FIGS. 1 and 2, the key member 22 is employed as a restraining member for stopping the output piston 8 at the retracted end upon abutting contact on the rear wall of the booster shell 1. Thus, the retracted end of the plunger 21 relative to the output piston 8 can be limited to a predetermined distance by means of a simple and inexpensive construction of the key member 22 for stopping the output piston 8 at the retracted end.

Also in the first embodiment typically shown in FIGS. 2 and 3, the relative rotation between the output piston 8 and the valve member 31 is prevented by means of the key member 22. Since the key member 22 for defining the retracted end of the plunger 21 relative to the output piston 8 also serves to prevent the relative rotation between the output piston 8 and the valve member 31, the negative pressure valves 30 and the negative pressure valve seats 8h can be reliably kept in contactable relation through the simplified construction.

Also in the first embodiment typically shown in FIG. 2, the slidable, cylindrical portion 8b is protruded backward from the output piston 8 to encircle the negative pressure valve seats 8h and air-tightly passes through the rear wall of the booster shell 1. The valve member 31 is received in the slidable, cylindrical portion 8b slidably in the forward and backward direction and is urged forward by means of the compression spring 37. Since the valve member 31 is received in the slidable, cylindrical portion 8b protruding backward from the output piston 8, the brake boost device can be provided having the valve mechanism 30 which is simplified in construction, stable in valving operation, and reliable in air-tight capability.

In the second embodiment shown in FIG. 5, the valve member 41 is provided at its rear end with the slidable, cylindrical portion 41e which air-tightly passes through the rear wall of the booster shell 1, and the cylindrical forward end portion of the valve member 41 is slidably guided on the guide portion 40e which is formed on the output piston 40 radially inside of the negative pressure valve seats 40h. Since the slidable, cylindrical portion 41e provided at the rear portion of the valve member 41 and air-tightly passing through the rear wall of the booster shell 1 is guided by the rear wall of the booster shell 1 and since the cylindrical forward end portion of the valve member 41 is slidably fit on the guide portion 40e which is formed on the output piston 40 radially inside of the negative pressure valve seats 40h, the valve member 41 can be reliably guided, so that the valve mechanism which is stable in valving operation, highly responsive, reliable in air-tight capability and large in productivity can be provided at a low cost.

Also in the second embodiment shown in FIG. 5, the plunger 21 is slidably guided at its forward end portion 21b in the output piston 40 and is also slidably guided at its rear end portion in the valve member 41 behind the annular atmosphere valve 43. Since the forward and rear end portions of the plunger 21 are guided respectively by the output piston 40 and the valve member 41, the valve mechanism can be stable in operation and reliable in air-tight capability.

Also in the second embodiment shown in FIG. 5, the valve member 41 is constituted in such a way that the slidable, cylindrical portion 41e is press-fit and joined with the valve main body portion 41d having the negative pressure valves 42 and the atmosphere valve 43 formed thereon. Since the press-fitting is employed to join the slidable, cylindrical portion 41e with the valve main body portion 41d having the negative pressure valves 42 and the atmosphere valve 43 thereon, the valve member 41 can be manufactured in high productivity and at low cost.

Although in the illustrated embodiments, the negative pressure valve seats 8h (40H), the negative pressure valves 32 (42), the communication passages 31a (41a) and the passage 8i (40i) are provided at diametrically opposed both sides in terms of better pressure balance, they may be provided at only one side in the radial direction.

Obviously, numerous modifications and variations of the present invention are possible in light of the above teachings. It is therefore to be understood that within the scope of the appended claims, the present invention may be practiced otherwise than as specifically described herein.

1. A brake booster device comprising:
a booster shell having a partition member partitioning the interior of said booster shell into a variable pressure chamber and a constant pressure chamber;
an output piston secured to said partition member and having at least one negative pressure valve seat formed thereon;
an output rod;
a reaction mechanism for transmitting the movement in the forward and backward direction of said partition member, caused by the pressure difference between said variable and constant pressure chambers, from said output piston to said output rod;
a plunger operable in connection with said reaction mechanism and having an atmosphere valve seat formed thereon;
an input rod connected to said plunger for axially moving said plunger when axially moved by a brake pedal;
a valve member having at least one negative pressure valve and an atmosphere valve formed thereon, said negative pressure valve being contactable with said negative pressure valve seat for selective communication of said variable pressure chamber with said constant pressure chamber, said atmosphere valve being contactable with said atmosphere valve seat for selective communication of said variable pressure chamber with the atmosphere;
a first spring urging said valve member to bring said negative pressure valve and said atmosphere valve respectively into contact with said negative pressure valve seat and said atmosphere valve seat;
a second spring urging said plunger to move backward away from said output rod; and
a restraining member for restraining the backward movement of said plunger caused by said second spring, relative to said output piston; wherein:
said negative pressure valve seat is protruded from a rear end flat surface portion of said output piston to encircle a passage communicating with said constant pressure chamber;
said atmosphere valve seat is formed at the rear surface of said plunger annularly to encircle an atmosphere leading passage;
said negative pressure valve and said atmosphere valve contactable respectively with said negative pressure valve seat and said atmosphere valve seat are formed on said valve member at respective portions thereon spaced in the axial direction of said valve member; and
a communication passage is formed at the outer surface of said valve member between said negative pressure valve and said atmosphere valve to make the interior of said valve member communicate with said variable pressure chamber.

2. The brake booster device as set forth in claim 1, wherein said restraining member comprises a key member for stopping said output piston at a retracted end upon engagement with a rear wall of said booster shell.

3. The brake booster device as set forth in claim 2, wherein said key member also serves to prevent said output piston and said valve member from rotating relative to each other.

4. The brake booster device as set forth in claim 1, wherein:
a slidable, cylindrical portion having said negative pressure valve seat radially inside thereof is protruded backward from said output piston to pass air-tightly through a rear wall of said booster shell; and
said valve member is received in said slidable, cylindrical portion slidably in said forward and backward direction and is urged by said first spring forward.

5. The brake booster device as set forth in claim 1, wherein:
said valve member is provided at a rear end portion thereof with a slidable, cylindrical portion which air-tightly passes through a rear wall of said booster shell; and
the cylindrical forward end portion of said valve member is slidably fit on a guide portion which is formed on said output piston radially inside of said negative pressure valve seat.

6. The brake booster device as set forth in claim 5, wherein said plunger is slidably inserted at its forward end portion into said output piston and is also slidably inserted at its rear end portion into said valve member behind said atmosphere valve seat annularly formed at the rear surface of said plunger.

7. The brake booster device as set forth in claim 5, wherein said valve member is composed of a valve main body portion having said negative pressure valve and said atmosphere valve formed thereon and a slidable, cylindrical portion press-fit on said valve main body portion to be joined bodily therewith.
